(19) United States
(12) Patent Application Publication
(10) Pub. No.: US 2023/0082423 A1
(43) Pub. Date: Mar. 16, 2023

(54) GLASS, CRYSTALLIZED GLASS AND CHEMICALLY STRENGTHENED GLASS

(71) Applicant: AGC Inc., Tokyo (JP)

(72) Inventors: Kazuki KANEHARA, Tokyo (JP); Yutaka KUROIWA, Tokyo (JP); Shusaku AKIBA, Tokyo (JP); Hiroyuki HIJIYA, Tokyo (JP)

(73) Assignee: AGC Inc., Tokyo (JP)

(21) Appl. No.: 18/053,820

(22) Filed: Nov. 9, 2022

Related U.S. Application Data
(63) Continuation of application No. PCT/JP2021/025224, filed on Jul. 2, 2021.

(30) Foreign Application Priority Data
Jul. 3, 2020 (JP) 2020-115920

(51) Int. Cl. C03C 3/097; C03C 10/00; C03C 3/085; C03C 3/093; C03C 3/091

(52) U.S. Cl. CPC C03C 3/097; C03C 10/0027; C03C 3/085; C03C 3/093; C03C 3/091; C03C 2204/00

(57) ABSTRACT

The present invention relates to a glass including, in terms of mole percentage based on oxides: 50.0 to 75.0% of SiO₂; 7.5 to 25.0% of Al₂O₃; 0 to 25.0% of B₂O₃; 6.5 to 20.0% of Li₂O; 1.5 to 10.0% of Na₂O; 0 to 4.0% of K₂O; 1.0 to 20.0% of MgO; one or more components selected from MgO, CaO, SrO, and BaO in a total amount of 1.0 to 20.0%; and 0 to 5.0% of TiO₂, in which a value of Y calculated based on the following formula is 19.5 or less, Y=1.2×([MgO]+[CaO]+[SrO]+[BaO])+1.6×([Li₂O]+[Na₂O]+[K₂O]), provided that [MgO], [CaO], [SrO], [BaO], [Li₂O], [Na₂O], and [K₂O] are contents, in terms of mole percentage based on oxides, of components of MgO, CaO, SrO, BaO, Li₂O, Na₂O, and K₂O respectively.

### TECHNICAL FIELD

The present invention relates to glass, glass ceramics, and chemically strengthened glass.

### BACKGROUND ART

A chemically strengthened glass is widely used for a cover glass or the like of a mobile terminal since the cover glass is required to have sufficient strength to prevent the cover glass from easily cracking even if the mobile terminal is dropped. The chemically strengthened glass is a glass in which a compressive stress layer is formed on a surface portion of the glass by using a method of immersing the glass into a molten salt such as sodium nitrate to cause ion exchange between alkali ions contained in the glass and alkali ions that have a larger ionic radius and are contained in the molten salt. For example, Patent Literature 1 discloses an aluminosilicate glass having a specific composition and capable of obtaining high surface compressive stress by chemical strengthening. Patent Literature 2 discloses a glass article including SiO₂, Al₂O₃, B₂O₃, Li₂O, and SnO₂ and having a fusion line, and describes that such a glass article can be reinforced by an ion exchange process.

Further, in a communication device such as a mobile phone, a smart phone, a mobile information terminal, and a Wi-Fi device, a surface acoustic wave (SAW) device, and an electronic device such as a radar component and an antenna component, a signal frequency has been further increased in order to increase a communication capacity and a communication speed. In recent years, as a new communication system using a higher frequency band, the fifth generation mobile communication system (5G) is expected to be widely used. In the high frequency band used in 5G, the cover glass may interfere with radio wave transmission and reception, and a cover glass having excellent radio wave transparency is required for a mobile terminal compatible with 5G.

As a glass having high radio wave transparency, that is, a glass having a low relative permittivity or a low dielectric loss tangent in the high frequency band as used in 5G, several alkali-free glasses have been developed so far (for example, Patent Literature 3).

### CITATION LIST

### Patent Literature

Patent Literature 1: JP2018-520082T

Patent Literature 2: JP2019-532906T

Patent Literature 3: WO 2019/181707

### SUMMARY OF INVENTION

### Technical Problem

However, it is difficult to chemically strengthen an alkali-free glass containing substantially no alkali ions, and thus it is difficult to achieve both radio wave transparency and strength. In a conventional chemically strengthened glass described in Patent Literatures 1 and 2, a relative permittivity and a dielectric loss tangent in a high frequency region are not particularly focused, and even if the strength is sufficient, the radio wave transparency cannot be said to be sufficient. Accordingly, an object of the present invention is to provide a glass having excellent strength obtained by chemical strengthening and having excellent radio wave transparency. Another object of the present invention is to provide a chemically strengthened glass having excellent strength and excellent radio wave transparency.

### Solution to Problem

As a result of studies, the present inventors have found that a glass having high strength obtained by chemical strengthening and having good radio wave transparency can be obtained by adjusting a glass composition, and arrived at the present invention.

That is, the present invention relates to a glass including, in terms of mole percentage based on oxides:

50.0 to 75.0% of SiO₂;

7.5 to 25.0% of Al₂O₃;

0 to 25.0% of B₂O₃;

6.5 to 20.0% of Li₂O;

1.5 to 10.0% of Na₂O;

0 to 4.0% of K₂O;

1.0 to 20.0% of MgO;

one or more components selected from MgO, CaO, SrO, and BaO in a total amount of 1.0 to 20.0%; and

0 to 5.0% of TiO₂,

in which a value of Y calculated based on the following formula is 19.5 or less,

Y=1.2×([MgO]+[CaO]+[SrO]+[BaO])+1.6×([Li₂O]+[Na₂O]+[K₂O])

provided that [MgO], [CaO], [SrO], [BaO], [Li₂O], [Na₂O], and [K₂O] are contents, in terms of mole percentage based on oxides, of components of MgO, CaO, SrO, BaO, Li₂O, Na₂O, and K₂O respectively.

In the glass of the present invention, a value of X calculated based on the following formula is preferably 30.0 or more,

X=3×[Al₂O₃]+[MgO]+[Li₂O]−2×([Na₂O]+[K₂O])

provided that [Al₂O₃], [MgO], [Li₂O], [Na₂O], and [K₂O] are contents, in terms of mole percentage based on oxides, of components of Al₂O₃, MgO, Li₂O, Na₂O, and K₂O respectively.

The present invention relates to a glass including, in terms of mole percentage based on oxides:

55.0 to 75.0% of SiO₂;

9.1 to 25.0% of Al₂O₃;

0 to 14.0% of B₂O₃;

7.5 to 12.5% of Li₂O;

3.6 to 10.0% of Na₂O;

0 to 2.0% of K₂O;

one or more components selected from MgO, CaO, SrO, and BaO in a total amount of 0 to 13.0%; and

0 to 8.0% of ZnO,

in which a value of X is 25.0 or more and a value of Z is 22.0 or less, the values of X and Z being calculated based on the following formulas,

X=3×[Al₂O₃]+[MgO]+[Li₂O]−2×([Na₂O]+[K₂O])

Z=3×[Al₂O₃]−3×[B₂O₃]−2×[Li₂O]+4×[Na₂O]

provided that [Al₂O₃], [B₂O₃], [MgO], [Li₂O], [Na₂O], and [K₂O] are contents, in terms of mole percentage based on oxides, of components of Al₂O₃, B₂O₃, MgO, Li₂O, Na₂O, and K₂O respectively.

The present invention relates to a glass including, in terms of mole percentage based on oxides:

50.0 to 75.0% of SiO₂;

9.0 to 25.0% of Al₂O₃;

0 to 20.0% of B₂O₃;

6.5 to 14.5% of Li₂O;

2.5 to 10.0% of Na₂O;

0 to 4.0% of K₂O;

one or more components selected from MgO, CaO, SrO, and BaO in a total amount of 0 to 20.0%; and

0 to 3.0% of TiO₂,

in which a value of X is 35.0 or more and a total value of Y and Z is 35.0 or less, the values of X, Y, and Z being calculated based on the following formulas,

X=3×[Al₂O₃]+[MgO]+[Li₂O]−2×([Na₂O]+[K₂O])

Y=1.2×([MgO]+[CaO]+[SrO]+[BaO])+1.6×([Li₂O]+[Na₂O]+[K₂O])

Z=3×[Al₂O₃]−3×[B₂O₃]−2×[Li₂O]+4×[Na₂O]

provided that [Al₂O₃], [B₂O₃], [MgO], [CaO], [SrO], [BaO], [Li₂O], [Na₂O], and [K₂O] are contents, in terms of mole percentage based on oxides, of components of Al₂O₃, B₂O₃, MgO, CaO, SrO, BaO, Li₂O, Na₂O, and K₂O respectively.

In the glass of the present invention, a sheet thickness (t) is preferably 100 μm or more and 2000 μm or less.

The present invention relates to a chemically strengthened glass having a base composition including, in terms of mole percentage based on oxides:

50.0 to 75.0% of SiO₂;

0 to 25.0% of B₂O₃;

7.5 to 25.0% of Al₂O₃;

6.5 to 20.0% of Li₂O;

1.5 to 10.0% of Na₂O;

0 to 4.0% of K₂O;

1.0 to 20.0% of MgO;

one or more components selected from MgO, CaO, SrO, and BaO in a total amount of 1.0 to 20.0%; and

0 to 5.0% of TiO₂,

in which a value of Y calculated based on the following formula is 19.5 or less,

Y=1.2×([MgO]+[CaO]+[SrO]+[BaO])+1.6×([Li₂O]+[Na₂O]+[K₂O])

provided that [MgO], [CaO], [SrO], [BaO], [Li₂O], [Na₂O], and [K₂O] are contents, in terms of mole percentage based on oxides, of components of MgO, CaO, SrO, BaO, Li₂O, Na₂O, and K₂O respectively.

In the chemically strengthened glass of the present invention, a surface compressive stress value CS₀ is preferably 300 MPa or more.

In the chemically strengthened glass of the present invention, a compressive stress value CS₅₀ at a depth of 50 μm from a glass surface is preferably 75 MPa or more and a sheet thickness (t) is preferably 300 μm or more.

In the chemically strengthened glass of the present invention, a depth of a compressive stress layer (DOL) is preferably 80 μm or more and a sheet thickness (t) is preferably 350 μm or more.

The present invention relates to a glass ceramics having a glass composition of the glass of the present invention.

### Advantageous Effects of Invention

Since the glass of the present invention has a glass composition within a specific range, the glass exhibits high strength obtained by chemical strengthening and excellent radio wave transparency. The chemically strengthened glass of the present invention exhibits excellent strength and radio wave transparency.

### BRIEF DESCRIPTION OF DRAWINGS

FIG. 1 shows a relation between a parameter X and a surface compressive stress value CS₀ (Na) when the present glass is chemically strengthened in Example of the present glass.

FIG. 2 shows a relation between a parameter Y and a relative permittivity at 10 GHz in Example of the present glass.

FIG. 3 shows a relation between a parameter Z and a dielectric loss tangent tan δ at 10 GHz in Example of the present glass.

### DESCRIPTION OF EMBODIMENTS

In the present specification, the expression “to” indicating a numerical range is used to include numerical values described therebefore and thereafter as a lower limit value and an upper limit value. Hereinafter, the expression “to” in the present specification is used with the same meaning unless otherwise specified.

In the present specification, the term “chemically strengthened glass” refers to a glass after being subjected to a chemical strengthening treatment, and the term “glass for chemical strengthening” refers to a glass before being subjected to a chemical strengthening treatment.

In the present specification, the term “base composition of the chemically strengthened glass” is a glass composition of the glass for chemical strengthening. In the chemically strengthened glass, a glass composition at a depth of ½ of a sheet thickness t is the base composition of the chemically strengthened glass except for a case where an extreme ion exchange treatment is performed.

In the present specification, the glass composition is expressed in terms of mole percentage based on oxides unless otherwise specified, and mol % is simply expressed as “%”. In addition, in the present specification, “not substantially contained” means that an amount of a component is equal to or lower than a level of an impurity contained in a raw material or the like, that is, the component is not intentionally contained. Specifically, “not substantially contained” means, for example, a content being less than 0.1 mol %.

In the present specification, the term “stress profile” represents a compressive stress value with a depth from a glass surface as a variable. The term “depth of a compressive stress layer (DOL)” is a depth at which a compressive stress value (CS) is zero. The term “internal tensile stress value (CT)” refers to a tensile stress value at a depth of ½ of the sheet thickness t of the glass.

The stress profile in the present specification can be measured using a scattered light photoelastic stress meter (for example, SLP-1000 manufactured by Orihara Industrial Co., Ltd.). The scattered light photoelastic stress meter is affected by surface scattering, and measurement accuracy in a vicinity of a sample surface may decrease. However, for example, in a case where a compressive stress is generated only by ion exchange between lithium ions in a glass and external sodium ions, a compressive stress value represented by a function of a depth follows a complementary error function, and thus a stress value of a surface can be known by measuring an internal stress value. When the compressive stress value expressed by the function of the depth does not follow the complementary error function, the surface portion is measured by another method, for example, a method of measuring with a surface stress meter.

<Glass>

A glass according to an embodiment of the present invention (hereinafter, may be referred to as the present glass) is preferably a lithium aluminosilicate glass. The lithium aluminosilicate glass contains lithium ions that are alkali ions having the smallest ion radius, and thus a chemically strengthened glass having a preferable stress profile and excellent strength can be easily obtained by a chemical strengthening treatment in which ions are exchanged using various molten salts.

Specifically, the present glass preferably contains:

50.0 to 75.0% of SiO₂;

7.5 to 25.0% of Al₂O₃; and

6.5 to 20.0% of Li₂O.

In addition, the present glass further preferably contains:

0 to 25.0% of B₂O₃;

1.5 to 10.0% of Na₂O;

0 to 4.0% of K₂O; and

one or more components selected from MgO, CaO, SrO, and BaO in a total amount of 0 to 20.0%.

In the present glass, a value of a parameter X is preferably 25.0 or more, the parameter X being calculated based on a following formula using contents [Al₂O₃], [MgO], [Li₂O], [Na₂O], and [K₂O] of components of Al₂O₃, MgO, Li₂O, Na₂O, and K₂O in terms of mole percentage based on oxides. The value of the parameter X is more preferably 30.0 or more, still more preferably 35.0 or more, yet more preferably 37.5 or more, particularly preferably 40.0 or more, even more preferably 42.0 or more, and most preferably 45.0 or more.

X=3×[Al₂O₃]+[MgO]+[Li₂O]−2×([Na₂O]+[K₂O])

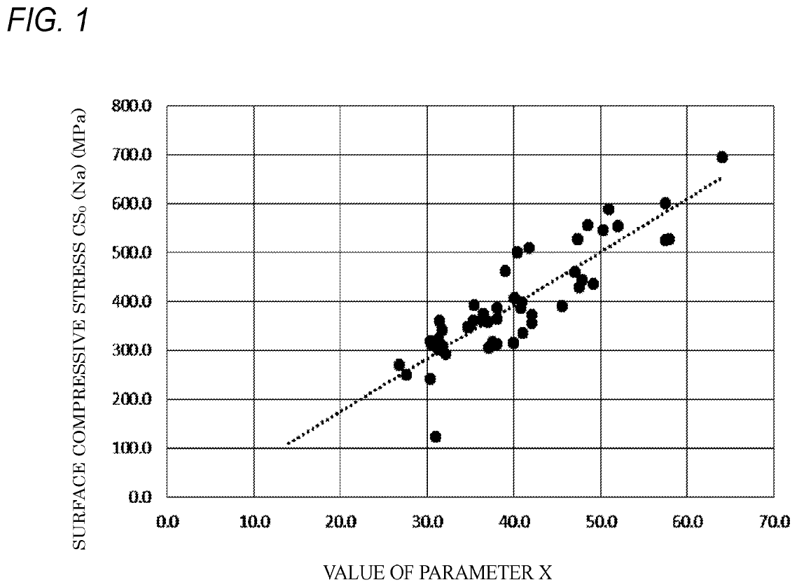

FIG. 1 shows a relation between the value of the parameter X and a surface compressive stress value CS₀ (Na) when the present glass is chemically strengthened in an example of the present glass. Here, the surface compressive stress value CS₀ (Na) refers to a surface compressive stress value when the glass is immersed in a salt of 100% sodium nitrate at 450° C. for 1 hour to be chemically strengthened. From FIG. 1, it can be confirmed that the CS₀ (Na) tends to increase as the value of the parameter X increases. That is, specifically, when the value of the parameter X is 25.0 or more, it is easy to obtain a chemically strengthened glass having excellent strength by chemical strengthening. From the viewpoint of glass strengthening time, the value of the parameter X is preferably 80.0 or less, more preferably 55.0 or less, still more preferably 50.0 or less, yet more preferably 49.0 or less, particularly preferably 48.0 or less, even more preferably 47.0 or less, and most preferably 46.0 or less.

In the present glass, a value of a parameter Y is preferably 19.5 or less, the parameter Y being calculated based on a following formula using contents [MgO], [CaO], [SrO], [BaO], [Li₂O], [Na₂O], and [K₂O] of components of MgO, CaO, SrO, BaO, Li₂O, Na₂O, and K₂O in terms of mole percentage based on oxides. The value of the parameter Y is more preferably 19.0 or less, still more preferably 18.5 or less, yet more preferably 18.25 or less, particularly preferably 18.0 or less, even more preferably 17.5 or less, and most preferably 17.0 or less.

In addition, when a large amount of B₂O₃ is contained, it is preferable to reduce a component that increases the value of Y from the viewpoint of preventing phase separation of the glass. Specifically, when B₂O₃ exceeds 5.0%, the value of Y is preferably 18.0 or less, more preferably 17.75 or less, still more preferably 17.5 or less, yet more preferably 17.25 or less, particularly preferably 17.0 or less, even more preferably 16.75 or less, and most preferably 16.5 or less.

Y=1.2×([MgO]+[CaO]+[SrO]+[BaO])+1.6×([Li₂O]+[Na₂O]+[K₂O])

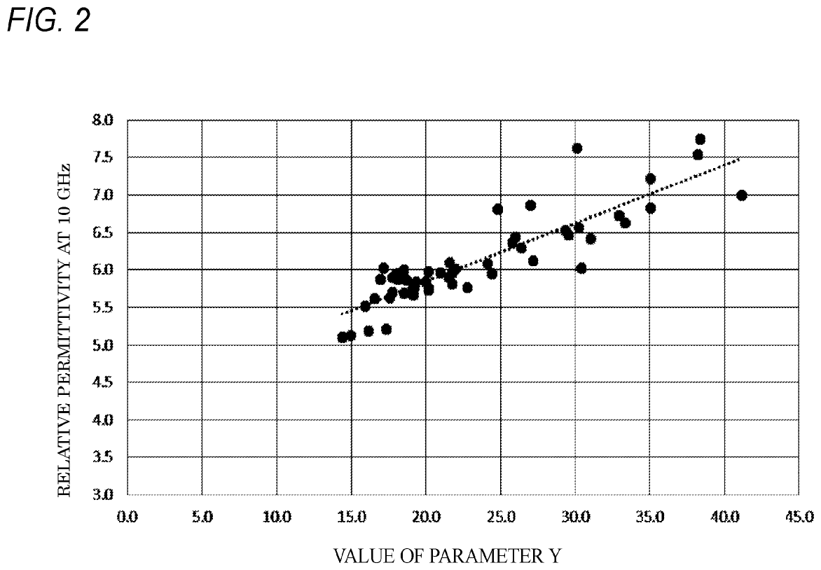

FIG. 2 shows a relation between the value of the parameter Y and a relative permittivity at 10 GHz in the example of the present glass. From FIG. 2, it can be confirmed that the relative permittivity at 10 GHz tends to decrease as the value of the parameter Y decreases. That is, specifically, when the value of the parameter Y is 19.5 or less, it is easy to obtain a glass having a smaller relative permittivity and good radio wave transparency. From the viewpoint of increasing the strength of the glass, the value of the parameter Y is preferably 10.0 or more, more preferably 11.0 or more, still more preferably 12.0 or more, yet more preferably 13.0 or more, particularly preferably 14.0 or more, even more preferably 15.0 or more, and most preferably 15.5 or more.

In the present glass, a value of a parameter Z is preferably 22.0 or less, more preferably 21.0 or less, still more preferably 20.0 or less, yet more preferably 19.0 or less, particularly preferably 18.0 or less, even more preferably 14.0 or less, and most preferably 12.0 or less, the parameter Z being calculated based on the following formula using contents [Al₂O₃], [B₂O₃], [Li₂O], and [Na₂O] of components of Al₂O₃, B₂O₃, Li₂O, and Na₂O in terms of mole percentage based on oxides.

Z=3×[Al₂O₃]−3×[B₂O₃]−2×[Li₂O]+4×[Na₂O]

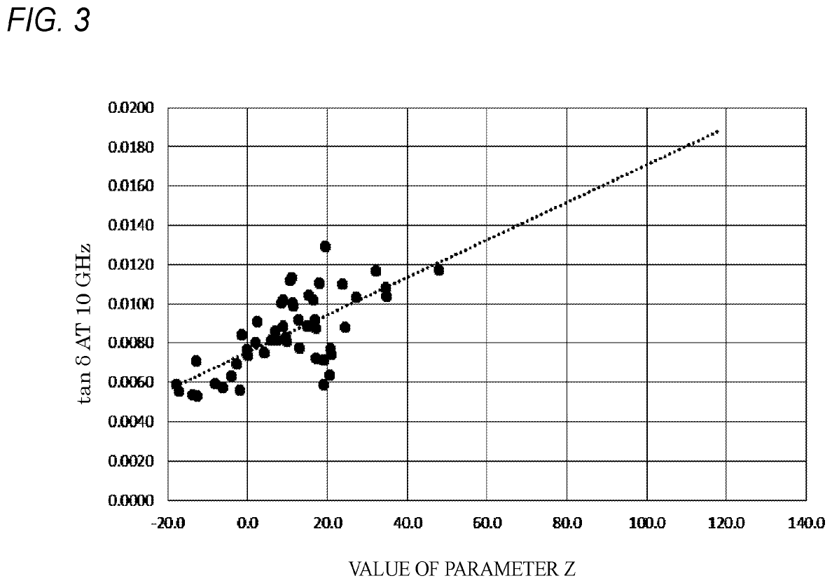

FIG. 3 shows a relation between the value of the parameter Z and a dielectric loss tangent tan δ at 10 GHz in the example of the present glass. It can be confirmed that the tan δ at 10 GHz tends to decrease as the value of the parameter Z decreases. That is, specifically, when the value of the parameter Z is 22.0 or less, it is easy to obtain a glass having a smaller dielectric loss tangent and good radio wave transparency. From the viewpoint of obtaining a high strength glass during chemical strengthening, the value of the parameter Z is preferably −5.0 or more, more preferably 0.0 or more, still more preferably 2.0 or more, yet more preferably 4.0 or more, particularly preferably 6.0 or more, even more preferably 8.0 or more, and most preferably 10.0 or more.

A total value of the parameter Y and the parameter Z of the present glass is preferably 35.0 or less, more preferably 33.0 or less, still more preferably 32.0 or less, yet more preferably 31.0 or less, particularly preferably 30.0 or less, even more preferably 29.0 or less, and most preferably 28.0 or less. In addition, when a large amount of B₂O₃ is contained, it is preferable to reduce a component that increases the values of Y and Z from the viewpoint of preventing the phase separation of the glass. Specifically, when B₂O₃ exceeds 5.0%, the value of Y+Z is preferably 34.0 or less, more preferably 32.0 or less, still more preferably 30.0 or less, yet more preferably 28.0 or less, particularly preferably 27.0 or less, even more preferably 26.0 or less, and most preferably 25.5 or less.

When the total value of the Y and the Z is 35.0 or less, it is easy to obtain a glass having a smaller relative permittivity, a smaller dielectric loss tangent, and good radio wave transparency. From the viewpoint of increasing the strength of the glass, the total value of the Y and the Z is preferably 0.0 or more, more preferably 10.0 or more, still more preferably 15.0 or more, yet more preferably 20.0 or more, particularly preferably 21.0 or more, even more preferably 23.0 or more, and most preferably 25.0 or more.

Hereinafter, a preferable composition of the present glass will be further described.

SiO₂ is a component constituting a network of a glass. In addition, SiO₂ is a component that increases chemical durability, and is a component that reduces the occurrence of cracks when the glass surface is scratched.

In order to improve the chemical durability, a content of SiO₂ is preferably 50.0% or more, more preferably 52.0% or more, still more preferably 55.0% or more, yet more preferably 56.0% or more, particularly preferably 60.0% or more, further particularly preferably 62.0% or more, even more preferably 64.0% or more, and most preferably 66.0% or more. On the other hand, in order to improve meltability during glass production, the content of SiO₂ is preferably 75.0% or less, more preferably 74.0% or less, still more preferably 72.0% or less, yet more preferably 71.0% or less, particularly preferably 70.0% or less, even more preferably 69.0% or less, and most preferably 68.0% or less.

Al₂O₃ is an effective component from the viewpoint of improving ion exchangeability during chemical strengthening and increasing a surface compressive stress after strengthening.

In order to improve the chemical durability and to improve the chemical strengthening properties, a content of Al₂O₃ is preferably 7.5% or more, more preferably 9.0% or more, still more preferably 9.1% or more, yet more preferably 9.5% or more, particularly preferably 10.0% or more, even more preferably 11.0% or more, and most preferably 12.0% or more. When the content of Al₂O₃ is too high, crystals tend to grow during melting. In order to prevent a decrease in yield due to devitrification defects, the content of Al₂O₃ is preferably 25.0% or less, more preferably 23.0% or less, still more preferably 21.0% or less, yet more preferably 20.0% or less, particularly preferably 16.0% or less, even more preferably 15.0% or less, and most preferably 13.5% or less.

Both SiO₂ and Al₂O₃ are components that stabilize a structure of the glass, and in order to reduce brittleness, a total content is preferably 57.5% or more, more preferably 65.0% or more, still more preferably 75.0% or more, yet more preferably 77.0% or more, and particularly preferably 79.0% or more.

Both SiO₂ and Al₂O₃ tend to increase a melting temperature of the glass. Therefore, in order to facilitate melting of the glass, the total content thereof is preferably 95.0% or less, more preferably 90.0% or less, still more preferably 87.0% or less, yet more preferably 85.0% or less, and particularly preferably 82.0% or less.

Li₂O is a component for forming a surface compressive stress by ion exchange, and is a component for improving the meltability of the glass. When the chemically strengthened glass contains Li₂O, a stress profile having a large surface compressive stress and a large compressive stress layer can be obtained by ion-exchanging Li ions of the glass surface with Na ions, and Na ions with K ions.

In order to increase the surface compressive stress during chemical strengthening, a content of Li₂O is preferably 6.5% or more, more preferably 7.1 or more, still more preferably 7.5% or more, yet more preferably 7.6% or more, particularly preferably 8.0% or more, further particularly preferably 8.1% or more, even more preferably 8.5% or more, and most preferably 9.0% or more.

When the content of Li₂O is too high, a crystal growth rate during glass forming increases, and a problem of a decrease in yield due to devitrification defects may increase. In order to prevent devitrification in a glass production process, the content of Li₂O is preferably 20.0% or less, more preferably 18.0% or less, still more preferably 16.0% or less, yet more preferably 14.5% or less, particularly preferably 14.0% or less, further particularly preferably 12.5% or less, even more preferably 12.0% or less, and most preferably 11.0% or less. In addition, when a content of the alkali ion is too high, the radio wave transparency tends to decrease. Accordingly, the content of Li₂O is preferably 12.0% or less, more preferably 11.0% or less, still more preferably 10.0% or less, and yet more preferably 9.5% or less from the viewpoint of improving the radio wave transparency.

Neither Na₂O nor K₂O is essential, but is a component that improves the meltability of the glass and decreases the crystal growth rate of the glass, and is preferably contained in order to improve the ion exchangeability.

Na₂O is a component for forming a surface compressive stress layer in a chemical strengthening treatment using a potassium salt, and is also a component that can improve the meltability of the glass. In order to obtain the effect, a content of Na₂O is preferably 1.5% or more, more preferably 2.5% or more, still more preferably 3.0% or more, yet more preferably 3.3% or more, particularly preferably 3.5% or more, even more preferably 3.6% or more, and most preferably 4.0% or more. When the content of Na₂O is too high, a compressive stress at a relatively deep portion from the surface is difficult to be increased by chemical strengthening, and thus, from this viewpoint, the content is preferably 10.0% or less, more preferably 9.0% or less, still more preferably 8.0% or less, yet more preferably 7.0% or less, particularly preferably 6.0% or less, even more preferably 5.5% or less, and most preferably 5.0% or less.

K₂O may be contained for a purpose of preventing devitrification in the glass production process. In a case where K₂O is contained, a content of K₂O is preferably 0.1% or more, more preferably 0.15% or more, still more preferably 0.2% or more, yet more preferably 0.25% or more, particularly preferably 0.3% or more, and even more preferably 0.4% or more. In order to further prevent devitrification, the content of K₂O is preferably 0.45% or more, more preferably 0.6% or more, still more preferably 0.7% or more, yet more preferably 0.8% or more, particularly preferably 0.9% or more, and even more preferably 1.0% or more. From the viewpoint of preventing an increase in brittleness and preventing a decrease in surface layer stress due to reverse exchange during strengthening, the content of K₂O is preferably 4.0% or less, more preferably 3.5% or less, still more preferably 3.0% or less, yet more preferably 2.5% or less, particularly preferably 2.0% or less, even more preferably 1.5% or less, still even more preferably 1.3% or less, and most preferably 1.1% or less.

In order to increase the meltability of the glass, a total content ([Na₂O]+[K₂O]) of Na₂O and K₂O is preferably 1.0% or more, more preferably 2.0% or more, still more preferably 3.0% or more, yet more preferably 4.0% or more, particularly preferably 5.0% or more, even more preferably 5.5% or more, and most preferably 6.0% or more. When the ([Na₂O]+[K₂O]) is too high, a decrease in the surface compressive stress value tends to occur, and thus, the ([Na₂O]+[K₂O]) is preferably 18.0% or less, more preferably 16.0% or less, still more preferably 15.0% or less, yet more preferably 14.0% or less, particularly preferably 12.0% or less, even more preferably 10.0% or less, and most preferably 8.0% or less.

Since the movement of an alkali component is prevented by allowing Na₂O and K₂O to coexist, it is preferable from the viewpoint of radio wave transparency.

None of MgO, CaO, SrO, and BaO is essential, but one or more components of MgO, CaO, SrO, and BaO may be contained from the viewpoint of enhancing stability of the glass or improving the chemical strengthening properties. In a case of containing these, a total content [MgO]+[CaO]+[SrO]+[BaO] of one or more components selected from MgO, CaO, SrO, and BaO is preferably 1.0% or more, more preferably 1.5% or more, still more preferably 2.0% or more, yet more preferably 2.5% or more, particularly preferably 3.0% or more, even more preferably 3.5% or more, and most preferably 5.0% or more. From the viewpoint of obtaining sufficient chemical strengthening stress during chemical strengthening or increasing radio wave transparency, the total content thereof is preferably 20.0% or less, more preferably 16.0% or less, still more preferably 15.0% or less, yet more preferably 14.0% or less, particularly preferably 13.0% or less, further particularly preferably 12.0% or less, even more preferably 10.0% or less, and most preferably 8.0% or less.

MgO may be contained in order to decrease viscosity during melting. In a case where MgO is contained, a content of MgO is preferably 1.0% or more, more preferably 1.5% or more, still more preferably 2.0% or more, yet more preferably 2.5% or more, particularly preferably 3.0% or more, even more preferably 3.5% or more, and most preferably 5.0% or more. When the content of MgO is too high, it is difficult to increase the compressive stress layer during the chemical strengthening treatment. The content of MgO is preferably 20.0% or less, more preferably 16.0% or less, still more preferably 15.0% or less, yet more preferably 14.0% or less, particularly preferably 12.0% or less, even more preferably 10.0% or less, and most preferably 8.0% or less.

CaO is a component for improving the meltability of the glass, and may be contained. In a case where CaO is contained, a content of CaO is preferably 0.1% or more, more preferably 0.15% or more, and still more preferably 0.5% or more. When the content of CaO is excessive, it is difficult to increase the compressive stress value during the chemical strengthening treatment. From this viewpoint, the content of CaO is preferably 5.0% or less, more preferably 4.0% or less, still more preferably 3.0% or less, and typically 1.0% or less.

ZnO is not essential, but is a component for improving the meltability of the glass and may be contained. In a case where ZnO is contained, a content of ZnO is preferably 0.2% or more, and more preferably 0.5% or more. In order to increase weathering resistance of the glass, the content of ZnO is preferably 8.0% or less, more preferably 5.0% or less, and still more preferably 3.0% or less.

ZnO, SrO, and BaO tend to deteriorate the chemical strengthening properties, and thus, in order to facilitate chemical strengthening, a total content [ZnO]+[SrO]+[BaO] of ZnO, SrO, and BaO is preferably less than 1.0%, and more preferably 0.5% or less. It is more preferable that ZnO, SrO, and BaO are not substantially contained.

ZrO₂ may not be contained, but is preferably contained from the viewpoint of increasing the surface compressive stress of the chemically strengthened glass. A content of ZrO₂ is preferably 0.1% or more, more preferably 0.15% or more, still more preferably 0.2% or more, particularly preferably 0.25% or more, and typically 0.3% or more. When the content of ZrO₂ is too high, the devitrification defects are likely to occur, and the compressive stress value is hardly increased during the chemical strengthening treatment. The content of ZrO₂ is preferably 2.0% or less, more preferably 1.5% or less, still more preferably 1.0% or less, and particularly preferably 0.8% or less.

Y₂O₃ is not essential, but it is preferable to contain Y₂O₃ in order to decrease the crystal growth rate while increasing the surface compressive stress of the chemically strengthened glass. In order to increase a fracture toughness value, it is preferable to contain at least one of Y₂O₃, La₂O₃, and ZrO₂ in a total amount of 0.2% or more. A total content of Y₂O₃, La₂O₃, and ZrO₂ is preferably 0.5% or more, more preferably 1.0% or more, and still more preferably 1.5% or more. In order to decrease a liquidus temperature and prevent devitrification, the total content thereof is preferably 6.0% or less, more preferably 5.0% or less, and still more preferably 4.0% or less.

In order to decrease a devitrification temperature and prevent devitrification, a total content of Y₂O₃ and La₂O₃ is preferably larger than the content of ZrO₂, and a content of Y₂O₃ is more preferably larger than the content of ZrO₂.

The content of Y₂O₃ is preferably 0.1% or more, more preferably 0.2% or more, still more preferably 0.5% or more, and particularly preferably 1.0% or more. When the content of Y₂O₃ is too high, it is difficult to increase the compressive stress layer during the chemical strengthening treatment. The content of Y₂O₃ is preferably 10.0% or less, more preferably 8.0% or less, still more preferably 5.0% or less, yet more preferably 3.0% or less, particularly preferably 2.0% or less, and further particularly preferably 1.5% or less.

La₂O₃ is not essential, but may be contained for the same reason as Y₂O₃. La₂O₃ is preferably 0.1% or more, more preferably 0.2% or more, still more preferably 0.5% or more, and particularly preferably 0.8% or more. When La₂O₃ is too much, it is difficult to increase the compressive stress layer during the chemical strengthening treatment, and thus, La₂O₃ is preferably 5.0% or less, more preferably 3.0% or less, still more preferably 2.0% or less, and particularly preferably 1.5% or less.

TiO₂ is not essential, but is a component for preventing solarization of the glass and may be contained. In a case where TiO₂ is contained, a content of TiO₂ is preferably 0.02% or more, more preferably 0.03% or more, still more preferably 0.04% or more, particularly preferably 0.05% or more, and typically 0.06% or more. When the content of TiO₂ is more than 5.0%, the devitrification is likely to occur, and the quality of the chemically strengthened glass may decrease. The content of TiO₂ is preferably 5.0% or less, more preferably 3.0% or less, still more preferably 2.0% or less, yet more preferably 1.0% or less, particularly preferably 0.5% or less, and particularly preferably 0.25% or less.

B₂O₃ is not essential, but may be contained for a purpose of reducing brittleness of the glass and improving crack resistance, and for a purpose of improving the radio wave transparency. In a case where B₂O₃ is contained, a content of B₂O₃ is preferably 2.0% or more, more preferably 3.0% or more, still more preferably 4.0% or more, yet more preferably 5.0% or more, particularly preferably 6.0% or more, even more preferably 7.0% or more, and most preferably 8.0% or more. When the content of B₂O₃ is too high, acid resistance tends to deteriorate, and thus the content of B₂O₃ is preferably 25.0% or less. The content of B₂O₃ is more preferably 20.0% or less, still more preferably 17.0% or less, yet more preferably 14.0% or less, particularly preferably 12.0% or less, even more preferably 10.0% or less, and most preferably 9.0% or less.

P₂O₅ is not essential, but may be contained for a purpose of increasing the compressive stress layer during chemical strengthening. In a case where P₂O₅ is contained, a content of P₂O₅ is preferably 0.5% or more, more preferably 1.0% or more, still more preferably 2.0% or more, yet more preferably 2.5% or more, particularly preferably 3.0% or more, even more preferably 3.5% or more, and most preferably 4.0% or more. From the viewpoint of increasing the acid resistance, the content of P₂O₅ is preferably 10.0% or less, more preferably 9.0% or less, still more preferably 8.0% or less, yet more preferably 7.0% or less, particularly preferably 6.0% or less, and even more preferably 5.0% or less.

A total content of B₂O₃ and P₂O₅ is preferably 0 to 35.0%, and is preferably 3.0% or more, more preferably 5.0% or more, still more preferably 7.0% or more, yet more preferably 9.0% or more, particularly preferably 11.0% or more, even more preferably 13.0% or more, and most preferably 15.0% or more. The total content of B₂O₃ and P₂O₅ is preferably 35.0% or less, and more preferably 25.0% or less. The total content is more preferably 23.0% or less, still more preferably 21.0% or less, particularly preferably 20.0% or less, even more preferably 19.0% or less, and most preferably 18.0% or less.

Nb₂O₅, Ta₂O₅, Gd₂O₃, and CeO₂ are components for preventing solarization of the glass and improving the meltability, and may be contained. When these components are contained, a total content thereof is preferably 0.03% or more, more preferably 0.1% or more, still more preferably 0.3% or more, and typically 0.5% or more. When the total content thereof is too high, it is difficult to increase the compressive stress value during the chemical strengthening treatment. From this viewpoint, the total content of these components is preferably 3.0% or less, more preferably 2.0% or less, and particularly preferably 1.0% or less.

Fe₂O₃ absorbs heat rays, and thus, the Fe₂O₃ has an effect of improving solubility of the glass, and is preferably contained when the glass is mass-produced using a large melting furnace. In this case, a content of Fe₂O₃ is preferably 0.002% or more, more preferably 0.005% or more, still more preferably 0.007% or more, and particularly preferably 0.01% or more, in terms of weight percentage based on oxides. On the other hand, coloring occurs when Fe₂O₃ is excessively contained, and thus, from the viewpoint of enhancing transparency of the glass, the content of Fe₂O₃ is preferably 0.3% or less, more preferably 0.04% or less, still more preferably 0.025% or less, and particularly preferably 0.015% or less, in terms of weight percentage based on oxides.

Here, all the iron oxide in the glass has been described as Fe₂O₃, but in practice, Fe(III) in an oxidized state and Fe(II) in a reduced state are generally mixed. Among these, Fe(III) causes coloring in yellow, Fe(II) causes coloring in blue, and the glass is colored in green due to the balance therebetween.

Furthermore, a coloring component may be added within a range that does not inhibit the achievement of desired chemical strengthening properties. Preferable examples of the coloring component include Co₃O₄, MnO₂, NiO, CuO, Cr₂O₃, V₂O₅, Bi₂O₃, SeO₂, CeO₂, Er₂O₃, and Nd₂O₃.

A content of the coloring component is preferably 5.0% or less in total, in terms of mole percent based on oxides. When the content exceeds 5.0%, the glass may tend to be devitrified. The content of the coloring component is preferably 3.0% or less, and more preferably 1.0% or less. When it is desired to increase transmittance of the glass, it is preferable that these components are not substantially contained.

SO₃, a chloride, a fluoride, or the like may be appropriately contained as a refining agent during melting of the glass. As₂O₃ is preferably not contained. When Sb₂O₃ is contained, a content of Sb₂O₃ is preferably 0.3% or less, more preferably 0.1% or less, and it is most preferable that Sb₂O₃ is not contained.

Specific examples of the preferable composition of the present glass include, but are not limited to, the following composition examples 1 to 4.

### COMPOSITION EXAMPLE 1

A glass containing:

50.0 to 75.0% of SiO₂;

7.5 to 25.0% of Al₂O₃;

0 to 25.0% of B₂O₃;

6.5 to 20.0% of Li₂O;

1.5 to 10.0% of Na₂O;

0 to 4.0% of K₂O;

1.0 to 20.0% of MgO;

one or more components selected from MgO, CaO, SrO, and BaO in a total amount of 1.0 to 20.0%; and 0 to 5.0% of TiO₂, in which a value of Y is 19.5 or less.

Composition Example 1 is preferable as a glass having high strength obtained by chemical strengthening and good radio wave transparency can be easily obtained. In addition, the glass of Composition Example 1 has a smaller relative permittivity and a smaller dielectric loss tangent, and thus, both absorption and reflection of radio waves can be prevented, and radio waves are easily transmitted.

### COMPOSITION EXAMPLE 2

A glass containing:

50.0 to 75.0% of SiO₂;

7.5 to 25.0% of Al₂O₃;

0 to 25.0% of B₂O₃;

6.5 to 20.0% of Li₂O;

1.5 to 10.0% of Na₂O;

0 to 4.0% of K₂O;

1.0 to 20.0% of MgO;

one or more components selected from MgO, CaO, SrO, and BaO in a total amount of 1.0 to 20.0%; and

0 to 5.0% of TiO₂, in which

a value of X is 30.0 or more, and a value of Y is 19.5 or less.

Composition Example 2 is preferable as a glass having high strength obtained by chemical strengthening and good radio wave transparency can be easily obtained. When the value of X is large, the glass of Composition Example 2 tends to be a glass having higher strength.

### COMPOSITION EXAMPLE 3

A glass containing:

55.0 to 75.0% of SiO₂;

9.1 to 25.0% of Al₂O₃;

0 to 14.0% of B₂O₃;

7.5 to 12.5% of Li₂O;

3.6 to 10.0% of Na₂O;

0 to 2.0% of K₂O;

one or more components selected from MgO, CaO, SrO, and BaO in a total amount of 0 to 13.0%; and

0 to 8.0% of ZnO, in which

a value of X is 25.0 or more, and a value of Z is 22.0 or less.

Composition Example 3 is preferable as a glass having high strength obtained by chemical strengthening and having a smaller dielectric loss tangent and good radio wave transparency can be easily obtained.

### COMPOSITION EXAMPLE 4

A glass containing:

50.0 to 75.0% of SiO₂;

9.0 to 25.0% of Al₂O₃;

0 to 20.0% of B₂O₃;

6.5 to 14.5% of Li₂O;

2.5 to 10.0% of Na₂O;

0 to 4.0% of K₂O;

one or more components selected from MgO, CaO, SrO, and BaO in a total amount of 0 to 20.0%; and

0 to 3.0% of TiO₂, in which

a value of X is 35.0 or more, and a total value of Y and Z is 35.0 or less.

Composition Example 4 is preferable as a glass having high strength obtained by chemical strengthening and having a smaller relative permittivity, a smaller dielectric loss tangent, and good radio wave transparency can be easily obtained.

The relative permittivity of the present glass at 20° C. and 10 GHz is preferably 7.0 or less, more preferably 6.5 or less, and still more preferably 6.0 or less. When the relative permittivity is small, a loss of radio waves due to reflection on a glass surface can be prevented, and thus the radio wave transparency tends to be good. A lower limit of the relative permittivity is not particularly limited, but is generally 4.0 or more.

The dielectric loss tangent (tan δ) at 20° C. and 10 GHz of the present glass is preferably 0.015 or less, more preferably 0.012 or less, and still more preferably 0.01 or less. When the dielectric loss tangent is small, a loss when the radio waves pass through the inside of the glass can be prevented, and thus the radio wave transparency tends to be good. A lower limit of the dielectric loss tangent is not particularly limited, but is generally 0.001 or more.

It is preferable that the values of the relative permittivity and the dielectric loss tangent at 20° C. and 10 GHz and the values of the relative permittivity and the dielectric tangent at a higher frequency are brought close to each other, and frequency dependence (dielectric dispersion) is reduced, so that frequency characteristics of dielectric characteristics are hardly changed, and a design change is small even when frequencies during use are different.

The relative permittivity and the dielectric loss tangent can be adjusted by the composition of the glass.

Since an alkali content of the present glass is appropriately adjusted in the glass composition, the relative permittivity and the dielectric loss tangent at 10 GHz are small. In general, in a frequency range of about 10 GHz to 40 GHz, the relative permittivity and the dielectric loss tangent of the glass have small frequency dependence, and thus, the present glass having excellent dielectric characteristics at 10 GHz is excellent in radio wave transparency even in a band of 28 GHz, 35 GHz, or the like used in 5G.

The relative permittivity and the dielectric loss tangent can be measured using a cavity resonator and a vector network analyzer in accordance with a method prescribed in JIS R1641 (2007).

Aβ-OH value is a value used as an index of a moisture content of the glass, and is a value obtained by measuring absorbance for light having a wavelength of 2.75 to 2.95 μm and dividing a maximum value βₘₐₓ by a thickness (mm) of the glass.

It is preferable to set the β-OH value to 0.8 mm⁻¹ or less as the radio wave transparency of the glass can be further improved. The β-OH value is more preferably 0.6 mm⁻¹ or less, still more preferably 0.5 mm⁻¹ or less, and yet more preferably 0.4 mm⁻¹ or less.

Further, it is preferable that by setting the β-OH value to 0.05 mm⁻¹ or more, it is unnecessary to perform dissolution in an extreme dry atmosphere or extremely reduce a moisture content in a raw material, and the productivity, foam quality, and the like of the glass can be enhanced. The β-OH value is more preferably 0.1 mm⁻¹ or more, and still more preferably 0.2 mm⁻¹ or more.

The β-OH value can be adjusted by the composition of the glass, a heat source during melting, a melting time, and the raw material.

In the present glass, the surface compressive stress value CS₀ (Na) when the glass is immersed in a salt of 100% sodium nitrate at 450° C. for 1 hour to be chemically strengthened is preferably 230 MPa or more, more preferably 250 MPa or more, still more preferably 300 MPa or more, yet more preferably 350 MPa or more, and particularly preferably 400 MPa or more. Since the value of CS₀ (Na) is 230 MPa or more, sufficient compressive stress is easily generated and excellent strength is easily obtained when the present glass is chemically strengthened. It is preferable that when the value of CS₀ (Na) is large to some extent, the compressive stress value CS₅₀ at a depth of 50 μm from the surface also tends to be large. When the value of CS₀ (Na) is too large, a large tensile stress may be generated inside the chemically strengthened glass, which may lead to breakage, and thus the value of CS₀ (Na) is preferably 800 MPa or less, and more preferably 700 MPa or less.

The fracture toughness value of the present glass is preferably 0.70 MPa·m^{1/2} or more, more preferably 0.75 MPa·m^{1/2} or more, still more preferably 0.80 MPa·m^{1/2} or more, and particularly preferably 0.83 MPa·m^{1/2} or more. The fracture toughness value is generally 2.0 MPa·m^{1/2} or less, and typically 1.5 MPa·m^{1/2} or less. When the fracture toughness value is large, even if large surface compressive stress is introduced into the glass by chemical strengthening, intense crushing is less likely to occur.

The fracture toughness value can be measured using, for example, a DCDC method (Acta metall. Vol. 43, pp. 3453-3458, 1995).

In order to make the glass harder to crush, a Young's modulus of the present glass is preferably 80 GPa or more, more preferably 82 GPa or more, still more preferably 84 GPa or more, and particularly preferably 85 GPa or more. An upper limit of the Young's modulus is not particularly limited, but the glass having a high Young's modulus may have low acid resistance, and thus the Young's modulus is, for example, preferably 110 GPa or less, more preferably 100 GPa or less, and still more preferably 90 GPa or less. The Young's modulus can be measured by, for example, an ultrasonic pulse method.

From the viewpoint of reducing warpage after chemical strengthening, an average linear thermal expansion coefficient (thermal expansion coefficient) of the present glass at 50° C. to 350° C. is preferably 95×10⁻⁷/° C. or less, more preferably 90×10⁻⁷/° C. or less, still more preferably 88×10⁻⁷/° C. or less, particularly preferably 86×10⁻⁷/° C. or less, and most preferably 84×10⁻⁷/° C. or less. A lower limit of the thermal expansion coefficient is not particularly limited, but a glass having a small thermal expansion coefficient may be difficult to melt, and thus, the average linear thermal expansion coefficient (thermal expansion coefficient) of the present glass at 50° C. to 350° C. is, for example, preferably 60×10⁻⁷/° C. or more, more preferably 70×10⁻⁷/° C. or more, still more preferably 74×10⁻⁷/° C. or more, and yet more preferably 76×10⁻⁷/° C. or more.

From the viewpoint of reducing warpage after chemical strengthening, a glass transition point (Tg) is preferably 500° C. or higher, more preferably 520° C. or higher, and still more preferably 540° C. or higher. From the viewpoint of facilitating float forming, Tg is preferably 750° C. or lower, more preferably 700° C. or lower, still more preferably 650° C. or lower, particularly preferably 600° C. or lower, and most preferably 580° C. or lower.

A temperature (T2) at which the viscosity is 10² dPa·s is preferably 1750° C. or lower, more preferably 1700° C. or lower, still more preferably 1675° C. or lower, and particularly preferably 1650° C. or lower. The temperature (T2) is a temperature as a reference of a melting temperature of the glass, and there is a tendency that the lower the T2 is, the more easily the glass is produced. A lower limit of T2 is not particularly limited, but a glass having a low T2 tends to have an excessively low glass transition point, and thus, T2 is for example, preferably 1400° C. or higher, and more preferably 1450° C. or higher.

A temperature (T4) at which the viscosity is 10⁴ dPa·s is preferably 1350° C. or lower, more preferably 1300° C. or lower, still more preferably 1250° C. or lower, and particularly preferably 1150° C. or lower. The temperature (T4) is a temperature as a reference of a temperature at which the glass is formed into a sheet shape, and a glass having a high T4 tends to impose a high load on a forming facility. A lower limit of T4 is not particularly limited, but a glass having a low T4 tends to have an excessively low glass transition point, and thus, T4 is for example, preferably 900° C. or higher, more preferably 950° C. or higher, and still more preferably 1000° C. or higher.

A devitrification temperature of the present glass is preferably equal to or lower than a temperature higher by 120° C. than the temperature (T4) at which the viscosity is 10⁴ dPa·s because devitrification hardly occurs during forming by a float method. The devitrification temperature is more preferably equal to or lower than a temperature higher by 100° C. than T4, still more preferably equal to or lower than a temperature higher by 50° C. than T4, and particularly preferably T4 or less.

A softening point of the present glass is preferably 850° C. or lower, more preferably 820° C. or lower, and still more preferably 790° C. or lower. This is because, as the softening point of the glass is lower, a heat treatment temperature in bending forming is lower, energy consumption is smaller, and a load on a facility is also smaller. From the viewpoint of lowering a bending forming temperature, the softening point is preferably as low as possible, but is 700° C. or higher for a general glass. A glass having an excessively low softening point tends to have a low strength because the stress introduced during the chemical strengthening treatment is likely to be relaxed, and therefore, the softening point is preferably 700° C. or higher. The softening point is more preferably 720° C. or higher, and still more preferably 740° C. or higher. The softening point can be measured by a fiber elongation method described in JIS R3103-1:2001.

In the present glass, a crystallization peak temperature measured by the following measurement method is preferably higher than the softening point −100° C. In addition, it is more preferable that a crystallization peak is not observed.

That is, about 70 mg of glass is crushed and ground in an agate mortar, and the crystallization peak temperature is measured using a differential scanning calorimeter (DSC) from room temperature to 1000° C. at a temperature rising rate of 10° C./min.

When the present glass has a sheet shape (a glass sheet), a sheet thickness (t) thereof is, for example, 2 mm or less, preferably 1.5 mm or less, more preferably 1 mm or less, still more preferably 0.9 mm or less, particularly preferably 0.8 mm or less, and most preferably 0.7 mm or less, from the viewpoint of enhancing an effect of chemical strengthening. From the viewpoint of obtaining an effect of sufficiently improving strength by the chemical strengthening treatment, the sheet thickness is for example, preferably 0.1 mm or more, more preferably 0.2 mm or more, still more preferably 0.3 mm or more, yet more preferably 0.35 mm or more, particularly preferably 0.4 mm or more, and further particularly preferably 0.5 mm or more.

A shape of the present glass may be a shape other than a sheet shape depending on an applicable product, a use, or the like. In addition, the glass sheet may have an edged shape in which thicknesses of an outer periphery are different. The form of the glass sheet is not limited thereto, and for example, two main surfaces may not be parallel to each other. All or a part of one or both of the two main surfaces may be curved surfaces. More specifically, the glass sheet may be, for example, a flat sheet shaped glass sheet having no warpage or a curved glass sheet having a curved surface.

The glass according to the embodiment of the present invention can be produced by a general method. For example, raw materials of the components of the glass are blended, and then heated and melted in a glass melting furnace. Thereafter, the glass is homogenized by a known method and formed into a desired shape such as a glass sheet, and is annealed.

Examples of a method of forming the glass sheet include a float method, a press method, a fusion method, and a down-draw method. In particular, the float method suitable for mass production is preferable. In addition, a continuous forming method other than the float method, such as a fusion method and a down-draw method, is also preferable.

Thereafter, the formed glass is subjected to a grinding and polishing treatment as necessary to form a glass substrate. In the case where the glass substrate is cut into a predetermined shape and size, or chamfering on the glass substrate is performed, it is preferable to perform cutting or chamfering to the glass substrate before performing the chemical strengthening treatment to be described later as a compressive stress layer is also formed on an end surface by a subsequent chemical strengthening treatment.

<Glass Ceramics>

Glass ceramics according to the embodiment of the present invention (hereinafter, also referred to as “the present glass ceramics”) are glass ceramics having the glass composition of the present glass described above.

The present glass ceramics preferably contains one or more kinds of crystal selected from a lithium silicate crystal, a lithium aluminosilicate crystal, a lithium phosphate crystal, a magnesium aluminosilicate crystal, a magnesium silicate crystal, and a silicate crystal. As the lithium silicate crystal, a lithium metasilicate crystal is more preferable. As the lithium aluminosilicate crystal, one or more kinds of crystal selected from a petalite crystal, a β-spodumene crystal, α-eucryptite, and β-eucryptite is preferable. As the lithium phosphate crystal, a lithium orthophosphate crystal is preferable.

In order to improve transparency, glass ceramics containing lithium metasilicate crystals are more preferable.

The glass ceramics are obtained by heating and crystallizing an amorphous glass having the same composition as that of the present glass. A glass composition of the glass ceramics is the same as a composition of the amorphous glass.

In the glass ceramics, a visible light transmittance (a total visible light transmittance including diffused transmitted light) is preferably 85% or more when a thickness of the glass ceramics is converted to 0.7 mm. Therefore, a screen of a display can be easily seen when the glass ceramics is used as a cover glass of a portable display. The visible light transmittance is more preferably 88% or more, and still more preferably 90% or more. The visible light transmittance is preferably as high as possible, but is generally 93% or less. A visible light transmittance of a normal amorphous glass is about 90% or more.

When the thickness of the glass ceramics is not 0.7 mm, the visible light transmittance in a case of 0.7 mm can be calculated using Lambert-Beer law based on a measured transmittance.

When the total visible light transmittance of the present glass having a sheet thickness t [mm] is 100×T [%] and the surface reflectance of one surface thereof is 100×R [%], a relation of T=(1−R)²×exp (−αt) is established using a constant α by incorporating Lambert-Beer law.

Here, if α is represented by R, T, and t, and t=0.7 mm, R does not change depending on the sheet thickness, and thus, the total visible light transmittance T_{0.7} in terms of 0.7 mm can be calculated as T_{0.7}=100×T^{0.7/t}/(1−R)^(1.4/t−2) [%]. Here, X^Y represents X^{Y}.

The surface reflectance may be determined by calculation from a refractive index or may be actually measured. In a case of a glass having a sheet thickness t larger than 0.7 mm, the visible light transmittance may be actually measured by adjusting the sheet thickness to 0.7 mm by polishing, etching, or the like.

When the thickness is converted to 0.7 mm, a haze value is preferably 1.0% or less, more preferably 0.4% or less, still more preferably 0.3% or less, particularly preferably 0.2% or less, and most preferably 0.15% or less. The haze value is preferably as small as possible, but when a crystallization rate is lowered or a crystal grain size is decreased in order to decrease the haze value, mechanical strength is reduced. In order to increase the mechanical strength, the haze value when the thickness is 0.7 mm is preferably 0.02% or more, and more preferably 0.03% or more. The haze value is a value measured in accordance with JIS K7136 (2000).

When the total visible light transmittance of the glass ceramics having a sheet thickness t [mm] is 100×T [%] and the haze value is 100×H [%], the following can be established using the constant α by incorporating Lambert-Beer law.

dH/dt∝exp(−αt)×(1−H)

That is, the haze value is considered to increase by an amount proportional to an internal linear transmittance as the sheet thickness increases, and thus, the haze value H_{0.7} in the case of 0.7 mm is determined by the following formula. Here, “X^Y” represents “X^{Y}”.

H_{0.7}=100×[1−(1−H)^{((1−R)²−T_{0.7})/((1−R)²−T)}][%]

In the case of the glass having the sheet thickness t larger than 0.7 mm, the haze value may be actually measured by adjusting the sheet thickness to 0.7 mm by polishing, etching, or the like.

When a strengthened glass obtained by strengthening the glass ceramics is used for a cover glass of a portable display, the strengthened glass preferably has a texture and high quality appearance different from plastic. Therefore, the refractive index of the present glass ceramics is preferably 1.52 or more, more preferably 1.55 or more, and still more preferably 1.57 or more at a wavelength of 590 nm.

In order to increase the mechanical strength, the crystallization rate of the glass ceramics is preferably 5% or more, more preferably 10% or more, still more preferably 15% or more, and particularly preferably 20% or more. In order to improve the transparency, the crystallization rate is preferably 70% or less, more preferably 60% or less, and particularly preferably 50% or less. A small crystallization rate is also excellent in terms of facilitating bending forming by heating.

The crystallization rate can be calculated by a Rietveld method based on an X-ray diffraction intensity. The Rietveld method is described in “Crystal Analysis Handbook” edited by Editing Committee of the Crystallographic Society of Japan (Kyoritsu Shuppan, 1999, pp. 492-499).

An average particle diameter of precipitated crystals of the glass ceramics is preferably 80 nm or less, more preferably 60 nm or less, still more preferably 50 nm or less, particularly preferably 40 nm or less, and most preferably 30 nm or less. The average particle diameter of the precipitated crystals is determined from a transmission electron microscope (TEM) image. The average particle diameter of the precipitated crystals can be estimated from a scanning electron microscope (SEM) image.

An average thermal expansion coefficient of the glass ceramics at 50° C. to 350° C. is preferably 90×10⁻⁷/° C. or more, more preferably 100×10⁻⁷/° C. or more, still more preferably 110×10⁻⁷/° C. or more, particularly preferably 120×10⁻⁷/° C. or more, and most preferably 130×10⁻⁷/° C. or more.

When the thermal expansion coefficient is too large, cracking may occur due to a difference in thermal expansion coefficient in a process of chemical strengthening, and thus, the average thermal expansion coefficient at 50° C. to 350° C. is preferably 160×10⁻⁷/° C. or less, more preferably 150×10⁻⁷/° C. or less, and still more preferably 140×10⁻⁷/° C. or less.

Since the glass ceramics contains crystals, hardness of the glass ceramics is large. For this reason, flaw is less likely to occur, and wear resistance is also excellent. In order to increase the wear resistance, the Vickers hardness is preferably 600 or more, more preferably 700 or more, still more preferably 730 or more, particularly preferably 750 or more, and most preferably 780 or more.

When the hardness is too high, it is difficult to process the glass, and thus, the Vickers hardness of the glass ceramics is preferably 1100 or less, more preferably 1050 or less, and still more preferably 1000 or less.

In order to prevent warpage due to strengthening during chemical strengthening, a Young's modulus of the glass ceramics is preferably 85 GPa or more, more preferably 90 GPa or more, still more preferably 95 GPa or more, particularly preferably 100 GPa or more. The glass ceramics may be polished for use. For ease of polishing, the Young's modulus is preferably 130 GPa or less, more preferably 125 GPa or less, and still more preferably 120 GPa or less.

A fracture toughness value of the glass ceramics is preferably 0.8 MPa·m^{1/2} or more, more preferably 0.85 MPa·m^{1/2} or more, still more preferably 0.9 MPa·m^{1/2} or more. It is preferable that the fracture toughness value is equal to or more than the above value because when the glass ceramics are chemically strengthened, broken pieces of the glass are less likely to scatter at the time of crushing.

The present glass ceramics has the same glass composition as that of the present glass described above. That is, the present glass ceramics are obtained by heating and crystallizing the amorphous glass having the same glass composition as that of the present glass. Since the present glass ceramics have the same glass composition as that of the present glass, the present glass ceramics have excellent strength obtained by chemical strengthening and excellent radio wave transparency as in the case of the present glass.

<Chemically Strengthened Glass>

A chemically strengthened glass (hereinafter also referred to as “the present chemically strengthened glass”) according to the embodiment of the present invention is obtained by chemically strengthening the present glass or the present glass ceramics described above. That is, a base composition of the present chemically strengthened glass is the same as the glass composition of the present glass described above, and a preferable composition range is also the same. In the chemically strengthened glass, a glass composition at a depth of ½ of a sheet thickness t is the same as the base composition of the chemically strengthened glass except for a case where an extreme ion exchange treatment is performed. In addition, an average composition of the present chemically strengthened glass is the same as the composition of the present glass or the present glass ceramics. Here, the average composition refers to a composition obtained by analyzing a finely pulverized glass sample that has been subjected to a heat treatment from a glass state.

A surface compressive stress value CS₀ of the present chemically strengthened glass is preferably 300 MPa or more, more preferably 350 MPa or more, still more preferably 400 MPa or more, yet more preferably 450 MPa or more, and particularly preferably 500 MPa or more. The surface compressive stress value CS₀ is preferably 300 MPa or more because excellent strength is easily obtained and a compressive stress value CS₅₀ at a depth of 50 μm from the surface tends to be large.

The larger the surface compressive stress value CS₀ is, the higher the strength is. However, when the surface compressive stress value CS₀ is too large, a large tensile stress may be generated inside the chemically strengthened glass and may lead to breakage. From this viewpoint, the surface compressive stress value CS₀ is preferably 1000 MPa or less, and more preferably 800 MPa or less.

In a stress profile of the present chemically strengthened glass, the compressive stress value CS₅₀ at the depth of 50 μm from the surface is preferably 75 MPa or more, more preferably 90 MPa or more, still more preferably 100 MPa or more, and particularly preferably 125 MPa or more. When CS₅₀ is large, the chemically strengthened glass is less likely to crack when damaged due to dropping or the like.

An internal tensile stress value CT of the present chemically strengthened glass is preferably 80 MPa or less, and more preferably 75 MPa or less. When CT is small, crushing hardly occurs. The internal tensile stress value CT is preferably 50 MPa or more, more preferably 60 MPa or more, and still more preferably 65 MPa or more. When the CT value is equal to or greater than the above value, the compressive stress in a vicinity of the surface increases, and the strength increases.

When a depth of a compressive stress layer (DOL) of the present chemically strengthened glass is too large with respect to the thickness t (μm), the CT is increased, and thus, the DOL is preferably 0.25t or less, more preferably 0.2t or less, still more preferably 0.19t or less, and yet more preferably 0.18t or less. In addition, from the viewpoint of improving the strength, the DOL is preferably 0.06t or more, more preferably 0.08t or more, still more preferably 0.10t or more, and particularly preferably 0.12t or more. Specifically, for example, when the sheet thickness t is 700 μm (0.7 mm), the DOL is preferably 140 μm or less, and more preferably 133 μm or less. The DOL is preferably 70 μm or more, more preferably 80 μm or more, and still more preferably 90 μm or more. A preferable sheet thickness (t) and a preferable shape of the present chemically strengthened glass are the same as the preferable sheet thickness (t) and the shape of the present glass described above.

The present chemically strengthened glass can be produced by subjecting the obtained glass sheet to a chemical strengthening treatment, followed by washing and drying.

The chemical strengthening treatment can be performed by a known method. In the chemical strengthening treatment, a glass sheet is brought into contact with a melt of a metal salt (for example, a potassium nitrate) containing metal ions (typically, K ions) having a large ionic radius by immersion or the like. Accordingly, metal ions having a small ionic radius (typically, Na ions or Li ions) in the glass sheet are substituted with metal ions having a large ionic radius (typically, K ions for Na ions and Na ions for Li ions).

The chemical strengthening treatment (ion exchange treatment) can be performed, for example, by immersing a glass sheet in a molten salt such as potassium nitrate heated to 360° C. to 600° C. for 0.1 to 500 hours. The heating temperature for the molten salt is preferably 375° C. to 500° C., and the immersion time of the glass sheet in the molten salt is preferably 0.3 to 200 hours.

Examples of the molten salt for performing the chemical strengthening treatment include a nitrate, a sulfate, a carbonate, and a chloride. Examples of the nitrate include lithium nitrate, sodium nitrate, potassium nitrate, cesium nitrate, and silver nitrate. Examples of the sulfate include lithium sulfate, sodium sulfate, potassium sulfate, cesium sulfate, and silver sulfate. Examples of the carbonate include lithium carbonate, sodium carbonate, and potassium carbonate. Examples of the chloride include lithium chloride, sodium chloride, potassium chloride, cesium chloride, and silver chloride. One of these molten salts may be used alone, or a plurality thereof may be used in combination.

In the present invention, appropriate treatment conditions of the chemical strengthening treatment may be selected in consideration of the properties and composition of the glass, the kind of the molten salt, and the chemical strengthening properties such as the surface compressive stress and the depth of the compressive stress layer desired for the chemically strengthened glass finally obtained.

In the present invention, the chemical strengthening treatment may be performed only once, or may be performed a plurality of times under two or more different conditions (multistage strengthening). Here, for example, as a chemical strengthening treatment in a first stage, the chemical strengthening treatment is performed under the condition that the DOL is made large and the CS is made relatively small. Thereafter, as a chemical strengthening treatment in a second stage, when the chemical strengthening treatment is performed under a condition that the DOL is made small and the CS is made relatively high, an internal tensile stress area (St) can be reduced while increasing the CS of the outermost surface of the chemically strengthened glass, and the internal tensile stress (CT) can be kept low.

The present glass is particularly useful as a cover glass used for a mobile device such as a mobile phone, a smartphone, a personal digital assistant (PDA), and a tablet terminal. Further, the present glass is also useful for applications which is not intended to be carried such as a cover glass of a display device such as a television (TV), a personal computer (PC), and a touch panel, an elevator wall surface, or a wall surface (full-screen display) of a construction such as a house and a building, a building material such as a window glass, a table top, an interior of an automobile, an airplane, or the like, and a cover glass thereof, or a casing having a curved surface shape that is not a sheet shape by bending or molding.

### EXAMPLES

Hereinafter, the present invention will be described with reference to Examples, but the present invention is not limited thereto.

Glass raw materials were blended so as to result in compositions shown in Tables 1 to 6 in terms of mole percentage based on oxides, and weighed such that the glass has a weight of 400 g. Next, the mixed raw materials were put into a platinum crucible, followed by being put into an electric furnace at 1500° C. to 1700° C., and were melted for about 3 hours, defoamed, and homogenized. In the tables, Mg+Ca+Sr+Ba means [MgO]+[CaO]+[SrO]+[BaO].

The obtained molten glass was poured into a metal mold, held at a temperature about 50° C. higher than the glass transition point for 1 hour, and then cooled to reach room temperature at a rate of 0.5° C./min to obtain a glass block. The obtained glass block was cut and ground, and finally both surfaces were mirror-polished to obtain a glass sheet having a thickness of 600 μm. Examples 1 to 50 are Examples of the present glass, and Examples 51 to 53 are Comparative Examples.

For the glass of each example, the relative permittivity ϵ′ and the dielectric loss tangent tan δ at 20° C. and 10 GHz were measured. Measurement was performed using a cavity resonator and a vector network analyzer in accordance with a method prescribed in JIS R1641 (2007). A measurement frequency was set to 20° C. and 10 GHz, which are resonance frequencies of air in the cavity resonator. The results are shown in Tables 1 to 6.

Each glass was immersed in a salt of 100% sodium nitrate at 450° C. for 1 hour and was chemically strengthened. A surface compressive stress value CS₀ (Na) and a depth of a compressive stress DOL after the chemical strengthening were measured using a scattered light photoelastic stress meter SLP-1000 manufactured by Orihara Industrial Co., Ltd. The results are shown in Tables 1 to 6. In the tables, blank columns mean that the measurement was not performed.

For the glasses of Examples 1 to 50, the relation between the value of the parameter X and the surface compressive stress value CS₀ (Na) after the chemical strengthening is shown in FIG. 1. From FIG. 1, it can be confirmed that the CS₀ (Na) tends to increase as the parameter X increases.

For the glasses of Examples 1 to 50, the relation between the value of the parameter Y and the relative permittivity at 20° C. and 10 GHz is shown in FIG. 2. From FIG. 2, it can be confirmed that the relative permittivity at 20° C. and 10 GHz tends to decrease as the value of the parameter Y decreases.

For the glasses of Examples 1 to 50, the relation between the value of the parameter Z and the dielectric loss tangent at 20° C. and 10 GHz is shown in FIG. 3. From FIG. 3, it can be confirmed that the dielectric loss tangent at 20° C. and 10 GHz tends to decrease as the value of the parameter Z decreases.

TABLE 1

| (mol %) | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|
| SiO₂ | 54.6 | 55.0 | 52.1 | 59.1 | 57.6 | 55.5 | 55.0 | 60.0 | 59.6 | 64.6 |
| Al₂O₃ | 9.5 | 16.0 | 9.5 | 9.5 | 13.0 | 13.0 | 15.0 | 10.0 | 10.0 | 10.0 |
| B₂O₃ | 9.5 | 9.0 | 7.0 | 5.0 | 7.0 | 3.0 | 8.0 | 10.0 | 7.0 | 8.0 |
| P₂O₅ | 0.0 | 1.0 | 3.0 | 0.0 | 0.0 | 0.0 | 2.0 | 0.0 | 1.0 | 1.0 |
| MgO | 0.0 | 2.0 | 0.0 | 5.0 | 5.0 | 0.0 | 2.0 | 5.0 | 5.0 | 5.0 |
| CaO | 0.0 | 1.0 | 0.0 | 5.0 | 0.0 | 5.0 | 0.0 | 3.0 | 0.0 | 0.0 |
| SrO | 5.0 | 0.0 | 5.0 | 0.0 | 0.0 | 0.0 | 0.0 | 0.0 | 3.0 | 0.0 |
| BaO | 5.0 | 0.0 | 5.0 | 0.0 | 1.0 | 5.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| TiO₂ | 0.0 | 0.0 | 0.0 | 0.0 | 0.0 | 0.0 | 0.0 | 0.0 | 0.0 | 0.0 |
| ZrO₂ | 2.0 | 1.0 | 2.0 | 2.0 | 2.0 | 2.0 | 0.0 | 1.0 | 1.0 | 0.9 |
| Y₂O₃ | 0.0 | 1.0 | 0.0 | 0.0 | 0.0 | 0.0 | 3.0 | 0.0 | 0.0 | 0.0 |
| Li₂O | 11.9 | 10.0 | 11.9 | 11.9 | 11.9 | 11.9 | 10.0 | 8.0 | 10.9 | 8.0 |
| Na₂O | 2.5 | 4.0 | 2.5 | 2.5 | 2.5 | 3.6 | 5.0 | 3.0 | 2.5 | 2.5 |
| K₂O | 0.0 | 0.0 | 2.0 | 0.0 | 0.0 | 1.0 | 0.0 | 0.0 | 0.0 | 0.0 |
| Sum | 100.0 | 100.0 | 100.0 | 100.0 | 100.0 | 100.0 | 100.0 | 100.0 | 100.0 | 100.0 |
| Mg + | 10.0 | 3.0 | 10.0 | 10.0 | 6.0 | 10.0 | 2.0 | 8.0 | 8.0 | 5.0 |
| Ca + Sr | | | | | | | | | | |
| + Ba | | | | | | | | | | |
| X | 35.4 | 52.0 | 35.4 | 40.4 | 50.9 | 43.7 | 47.0 | 37.0 | 40.9 | 38.0 |
| Y | 35.0 | 26.0 | 38.2 | 35.0 | 30.2 | 38.4 | 26.4 | 27.2 | 31.0 | 22.8 |
| Z | −13.8 | 17.0 | −6.3 | −0.3 | 4.2 | 20.6 | 21.0 | −4.0 | −2.8 | 0.0 |
| Y+ Z | 21.2 | 43.0 | 31.9 | 34.7 | 34.4 | 59.0 | 47.4 | 23.2 | 28.2 | 22.8 |
| CS₀ | 393 | 555 | 360 | 501 | 590 | 510 | 461 | 358 | 400 | 365 |
| (Na) | | | | | | | | | | |
| [MPa] | | | | | | | | | | |
| DOL | 77 | 157 | 126 | 94 | 107 | 108 | 172 | 108 | 107 | 140 |
| [μm] | | | | | | | | | | |
| ε′ @ 10 | 7.2 | 6.4 | 7.5 | 6.8 | 6.6 | 7.7 | 6.3 | 6.1 | 6.4 | 5.8 |
| GHz | | | | | | | | | | |
| tan δ @ | 0.0053 | 0.0072 | 0.0058 | 0.0077 | 0.0075 | 0.0064 | 0.0074 | 0.0063 | 0.0069 | 0.0074 |
| 10 GHz | | | | | | | | | | |

TABLE 2

| (mol %) | Ex. 11 | Ex. 12 | Ex. 13 | Ex. 14 | Ex. 15 | Ex. 16 | Ex. 17 | Ex. 18 | Ex. 19 | Ex. 20 |
|---|---|---|---|---|---|---|---|---|---|---|
| SiO₂ | 70.4 | 72.9 | 66.5 | 63.9 | 59.9 | 71.1 | 65.9 | 67.2 | 69.9 | 71.0 |
| Al₂O₃ | 10.0 | 10.0 | 10.0 | 15.0 | 18.0 | 9.8 | 12.0 | 11.7 | 10.0 | 10.4 |
| B₂O₃ | 5.0 | 2.5 | 4.0 | 4.0 | 7.9 | 5.5 | 8.4 | 8.5 | 5.0 | 0.0 |
| P₂O₅ | 1.0 | 1.0 | 4.0 | 4.0 | 2.0 | 0.0 | 0.0 | 0.0 | 10 | 5.6 |
| MgO | 2.5 | 1.0 | 1.0 | 2.0 | 1.0 | 1.0 | 0.0 | 0.0 | 0.0 | 1.0 |
| CaO | 0.0 | 1.5 | 0.0 | 0.0 | 0.0 | 0.0 | 0.0 | 0.0 | 0.0 | 0.0 |
| SrO | 0.0 | 0.0 | 0.0 | 0.0 | 0.0 | 0.0 | 0.4 | 0.0 | 0.0 | 0.0 |
| BaO | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| TiO₂ | 0.0 | 0.0 | 0.0 | 0.0 | 0.0 | 0.0 | 0.0 | 0.0 | 0.0 | 0.0 |
| ZrO₂ | 1.0 | 1.0 | 0.0 | 0.9 | 0.0 | 2.0 | 2.0 | 2.0 | 1.5 | 2.0 |
| Y₂O₃ | 0.0 | 0.0 | 0.0 | 0.0 | 2.0 | 0.0 | 0.0 | 0.0 | 0.0 | 0.0 |
| Li₂O | 8.0 | 8.0 | 10.9 | 7.1 | 7.1 | 7.1 | 7.7 | 7.1 | 9.0 | 6.5 |
| Na₂O | 2.1 | 2.1 | 3.6 | 2.1 | 2.1 | 3.5 | 3.6 | 3.5 | 3.6 | 3.5 |
| K₂O | 0.0 | 0.0 | 0.0 | 1.0 | 0.0 | 0.0 | 0.0 | 0.0 | 0.0 | 0.0 |
| Sum | 100.0 | 100.0 | 100.0 | 100.0 | 100.0 | 100.0 | 100.0 | 100.0 | 100.0 | 100.0 |
| Mg + | 2.5 | 2.5 | 1.0 | 2.0 | 1.0 | 1.0 | 0.4 | 0.0 | 0.0 | 1.0 |
| Ca + Sr | | | | | | | | | | |
| + Ba | | | | | | | | | | |
| X | 36.3 | 34.8 | 34.7 | 49.9 | 57.9 | 30.5 | 36.5 | 35.3 | 31.7 | 31.6 |
| Y | 19.2 | 19.2 | 24.4 | 18.7 | 15.9 | 18.2 | 18.6 | 17.0 | 20.2 | 17.2 |
| Z | 7.4 | 14.9 | 10.6 | 27.2 | 24.5 | 12.7 | 9.8 | 9.5 | 11.3 | 32.1 |
| Y + Z | 26.6 | 34.1 | 35.0 | 45.9 | 40.4 | 30.9 | 28.4 | 26.4 | 31.5 | 49.3 |
| CS₀ | 360 | 349 | 349 | 444 | 529 | 313 | 374 | 360 | 342 | 312 |
| (Na) | | | | | | | | | | |
| [MPa] | | | | | | | | | | |
| DOL | 158 | 167 | 217 | 238 | 208 | 145 | 145 | 150 | 163 | 288 |
| [μm] | | | | | | | | | | |
| ε′ @ 10 | 5.6 | 5.8 | 5.9 | 5.9 | 5.5 | 5.9 | 6.0 | 5.9 | 6.0 | 6.0 |
| GHz | | | | | | | | | | |
| tan δ | 0.0082 | 0.0088 | 0.0112 | 0.0104 | 0.0088 | 0.0092 | 0.0081 | 0.0083 | 0.0100 | 0.0117 |
| @ 10 | | | | | | | | | | |
| GHz | | | | | | | | | | |

TABLE 3

| (mol %) | Ex. 21 | Ex. 22 | Ex. 23 | Ex. 24 | Ex. 25 | Ex. 26 | Ex. 27 | Ex. 28 | Ex. 29 | Ex. 30 |
|---|---|---|---|---|---|---|---|---|---|---|
| SiO₂ | 69.9 | 62.4 | 61.5 | 67.4 | 69.7 | 63.4 | 62.1 | 66.8 | 69.4 | 67.9 |
| Al₂O₃ | 10.0 | 10.0 | 12.0 | 10.0 | 13.0 | 13.0 | 13.0 | 13.0 | 10.0 | 10.0 |
| B₂O₃ | 4.0 | 10.0 | 10.0 | 2.0 | 0.0 | 10.0 | 8.0 | 8.0 | 7.5 | 8.0 |
| P₂O₅ | 1.5 | 3.0 | 3.0 | 7.0 | 6.6 | 2.0 | 2.4 | 0.8 | 0.0 | 0.6 |
| MgO | 0.5 | 0.0 | 0.0 | 2.0 | 1.0 | 0.0 | 0.0 | 0.0 | 0.0 | 1.0 |
| CaO | 1.5 | 0.0 | 0.0 | 0.0 | 0.0 | 0.0 | 0.0 | 0.0 | 0.0 | 0.0 |
| SrO | 0.0 | 0.0 | 0.0 | 0.0 | 0.0 | 0.0 | 2.0 | 0.0 | 0.0 | 0.0 |
| BaO | 0.0 | 0.0 | 0.0 | 0.0 | 0.0 | 0.0 | 1.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| TiO₂ | 0.0 | 0.0 | 0.0 | 0.0 | 0.0 | 0.0 | 0.0 | 0.0 | 0.0 | 0.0 |
| ZrO₂ | 1.0 | 1.0 | 1.0 | 1.0 | 0.1 | 0.0 | 0.0 | 0.2 | 2.0 | 1.9 |
| Y₂O₃ | 0.0 | 0.0 | 0.0 | 0.0 | 0.0 | 0.0 | 0.0 | 0.0 | 0.0 | 0.0 |
| Li₂O | 8.0 | 8.0 | 9.0 | 7.1 | 7.1 | 7.1 | 8.0 | 7.1 | 7.5 | 7.1 |
| Na₂O | 3.6 | 3.6 | 3.5 | 3.5 | 2.5 | 3.5 | 3.5 | 4.0 | 3.6 | 3.5 |
| K₂O | 0.0 | 2.0 | 0.0 | 0.0 | 0.0 | 1.0 | 0.0 | 0.0 | 0.0 | 0.0 |
| Sum | 100.0 | 100.0 | 100.0 | 100.0 | 100.0 | 100.0 | 100.0 | 100.0 | 100.0 | 100.0 |
| Mg + | 2.0 | 0.0 | 0.0 | 2.0 | 1.0 | 0.0 | 3.0 | 0.0 | 0.0 | 1.0 |
| Ca + Sr | | | | | | | | | | |
| + Ba | | | | | | | | | | |
| X | 31.3 | 30.8 | 38.0 | 32.1 | 42.1 | 39.1 | 40.0 | 38.1 | 30.3 | 31.1 |
| Y | 21.0 | 21.8 | 20.0 | 19.4 | 16.6 | 18.6 | 22.0 | 17.8 | 17.8 | 18.2 |
| Z | 16.4 | −1.6 | 2.0 | 23.8 | 34.8 | 8.8 | 13.0 | 16.8 | 6.9 | 5.8 |
| Y + Z | 37.4 | 20.2 | 22.0 | 43.2 | 51.4 | 27.4 | 35.0 | 34.6 | 24.7 | 24.0 |
| CS₀ | 301 | 271 | 388 | 292 | 357 | 306 | 316 | 313 | 320 | 320 |
| (Na) | | | | | | | | | | |
| [MPa] | | | | | | | | | | |
| DOL | 176 | 181 | 205 | 305 | 314 | 181 | 186 | 170 | 144 | 155 |
| [μm] | | | | | | | | | | |
| ε′ @ 10 | 6.0 | 6.0 | 5.8 | 5.8 | 5.6 | 5.7 | 6.0 | 5.7 | 5.9 | 5.9 |
| GHz | | | | | | | | | | |
| tan δ | 0.0102 | 0.0084 | 0.0081 | 0.0110 | 0.0104 | 0.0088 | 0.0078 | 0.0092 | 0.0086 | 0.0081 |
| @ 10 | | | | | | | | | | |
| GHz | | | | | | | | | | |

TABLE 4

| (mol %) | Ex. 31 | Ex. 32 | Ex. 33 | Ex. 34 | Ex. 35 | Ex. 36 | Ex. 37 | Ex. 38 | Ex. 39 | Ex. 40 |
|---|---|---|---|---|---|---|---|---|---|---|
| SiO₂ | 68.9 | 70.8 | 71.0 | 58.9 | 65.4 | 69.4 | 56.0 | 62.4 | 50.5 | 55.0 |
| Al₂O₃ | 10.0 | 10.0 | 9.5 | 14.0 | 12.0 | 7.5 | 11.0 | 14.0 | 14.0 | 16.4 |
| B₂O₃ | 8.0 | 6.0 | 5.0 | 15.5 | 12.0 | 10.5 | 10.0 | 4.5 | 14.0 | 6.5 |
| P₂O₅ | 0.0 | 0.1 | 0.0 | 0.0 | 0.0 | 0.0 | 0.0 | 0.0 | 0.0 | 0.0 |
| MgO | 0.0 | 0.0 | 0.5 | 3.0 | 2.0 | 1.0 | 12.0 | 3.0 | 0.0 | 3.0 |
| CaO | 0.0 | 0.0 | 0.0 | 0.0 | 0.0 | 0.0 | 0.0 | 0.0 | 0.0 | 2.0 |
| SrO | 0.0 | 0.0 | 0.0 | 0.0 | 0.0 | 0.0 | 0.0 | 0.0 | 0.0 | 1.0 |
| BaO | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 2.0 | 0.0 | 0.0 | 2.0 | 0.0 |
| TiO₂ | 0.0 | 0.0 | 0.0 | 0.0 | 0.0 | 1.0 | 0.0 | 0.0 | 1.0 | 0.0 |
| ZrO₂ | 0.5 | 0.5 | 0.9 | 0.0 | 0.0 | 0.0 | 1.0 | 0.0 | 0.0 | 0.0 |
| Y₂O₃ | 0.0 | 0.0 | 0.0 | 0.0 | 0.0 | 0.0 | 0.0 | 0.0 | 0.0 | 0.0 |
| Li₂O | 9.0 | 9.0 | 9.5 | 7.1 | 7.1 | 7.1 | 7.5 | 12.5 | 14.5 | 12.5 |
| Na₂O | 3.6 | 3.6 | 3.6 | 1.5 | 1.5 | 1.5 | 2.5 | 3.6 | 4.0 | 3.6 |
| K₂O | 0.0 | 0.0 | 0.0 | 0.0 | 0.0 | 0.0 | 0.0 | 0.0 | 0.0 | 0.0 |
| Sum | 100.0 | 100.0 | 100.0 | 100.0 | 100.0 | 100.0 | 100.0 | 100.0 | 100.0 | 100.0 |
| Mg + | 0.0 | 0.0 | 0.5 | 3.0 | 2.0 | 1.0 | 12.0 | 3.0 | 0.0 | 6.0 |
| Ca + Sr | | | | | | | | | | |
| + Ba | | | | | | | | | | |
| X | 31.8 | 31.8 | 31.3 | 49.1 | 42.1 | 27.6 | 47.5 | 50.3 | 48.5 | 57.5 |
| Y | 20.2 | 20.2 | 21.6 | 17.4 | 16.2 | 15.0 | 30.4 | 29.4 | 29.6 | 33.0 |
| Z | 2.4 | 8.4 | 8.9 | −12.7 | −8.2 | −17.2 | −2.0 | 17.9 | −13.0 | 19.1 |
| Y + Z | 22.6 | 28.6 | 30.5 | 4.7 | 8.0 | −2.2 | 28.4 | 47.3 | 16.6 | 52.1 |
| CS₀ | 307 | 307 | 324 | 436 | 373 | 251 | 430 | 546 | 543 | 602 |
| (Na) | | | | | | | | | | |
| [MPa] | | | | | | | | | | |
| DOL | 133 | 140 | 133 | 131 | 136 | 126 | 86 | 112 | 99 | 112 |
| [μm] | | | | | | | | | | |
| ε′ @ 10 | 5.7 | 5.8 | 5.9 | 5.2 | 5.2 | 5.1 | 6.0 | 6.5 | 6.4 | 6.7 |
| GHz | | | | | | | | | | |
| tan δ | 0.0091 | 0.0101 | 0.0102 | 0.0053 | 0.0059 | 0.0056 | 0.0056 | 0.0111 | 0.0071 | 0.0071 |
| @ 10 | | | | | | | | | | |
| GHz | | | | | | | | | | |

TABLE 5

| (mol %) | Ex. 41 | Ex. 42 | Ex. 43 | Ex. 44 | Ex. 45 | Ex. 46 | Ex. 47 | Ex. 48 | Ex. 49 | Ex. 50 |
|---|---|---|---|---|---|---|---|---|---|---|
| SiO₂ | 74.0 | 57.0 | 60.4 | 63.9 | 62.0 | 69.9 | 56.0 | 64.3 | 55.0 | 59.0 |
| Al₂O₃ | 13.5 | 18.0 | 12.0 | 14.0 | 12.0 | 10.0 | 10.0 | 9.1 | 20.0 | 12.0 |
| B₂O₃ | 0.0 | 10.0 | 5.0 | 4.0 | 17.0 | 6.0 | 5.0 | 1.0 | 2.0 | 5.0 |
| P₂O₅ | 0.0 | 4.0 | 6.0 | 2.0 | 0.0 | 0.0 | 0.0 | 0.0 | 1.0 | 5.0 |
| MgO | 2.0 | 0.0 | 2.0 | 0.0 | 0.0 | 2.0 | 13.0 | 11.0 | 1.0 | 0.0 |
| CaO | 0.0 | 0.0 | 0.0 | 0.0 | 0.0 | 0.0 | 0.0 | 0.0 | 0.0 | 0.0 |
| SrO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 1.0 |
| TiO₂ | 0.0 | 0.0 | 1.0 | 0.0 | 0.0 | 0.0 | 0.0 | 0.0 | 0.5 | 1.0 |
| ZrO₂ | 0.0 | 0.0 | 0.0 | 0.0 | 0.0 | 0.0 | 0.0 | 2.0 | 0.0 | 1.0 |
| Y₂O₃ | 0.0 | 0.0 | 0.0 | 0.0 | 0.0 | 0.0 | 0.0 | 0.0 | 10.0 | 2.5 |
| Li₂O | 8.0 | 8.5 | 10.0 | 12.5 | 6.5 | 7.5 | 10.0 | 9.0 | 8.0 | 10.0 |
| Na₂O | 2.5 | 2.5 | 3.6 | 3.6 | 2.5 | 3.6 | 6.0 | 3.6 | 2.5 | 2.5 |
| K₂O | 0.0 | 0.0 | 0.0 | 0.0 | 0.0 | 1.0 | 0.0 | 0.0 | 0.0 | 1.0 |
| Sum | 100.0 | 100.0 | 100.0 | 100.0 | 100.0 | 100.0 | 100.0 | 100.0 | 100.0 | 100.0 |
| Mg + | 2.0 | 0.0 | 2.0 | 0.0 | 0.0 | 2.0 | 13.0 | 11.0 | 1.0 | 0.0 |
| Ca + Sr | | | | | | | | | | |
| + Ba | | | | | | | | | | |
| X | 45.5 | 57.5 | 40.8 | 47.3 | 37.5 | 32.3 | 41.0 | 40.1 | 64.0 | 41.0 |
| Y | 19.2 | 17.6 | 24.2 | 25.8 | 14.4 | 21.8 | 41.2 | 33.4 | 18.0 | 21.6 |
| Z | 34.5 | 17.0 | 15.4 | 19.4 | −18.0 | 11.4 | 19.0 | 20.7 | 48.0 | 11.0 |
| Y + Z | 53.7 | 34.6 | 39.6 | 45.2 | −3.6 | 33.2 | 60.2 | 54.1 | 66.0 | 32.6 |
| CS₀ | 392 | 525 | 388 | 528 | 318 | 243 | 335 | 407 | 694 | 462 |
| (Na) | | | | | | | | | | |
| [MPa] | | | | | | | | | | |
| DOL | 154 | 248 | 265 | 173 | 138 | 122 | 60 | 92 | 186 | 239 |
| [um] | | | | | | | | | | |
| ε′ @ 10 | 5.8 | 5.6 | 6.1 | 6.4 | 5.1 | 5.8 | 7.0 | 6.6 | 5.9 | 6.1 |
| GHz | | | | | | | | | | |
| tan δ | 0.0108 | 0.0088 | 0.0104 | 0.0129 | 0.0059 | 0.0099 | 0.0059 | 0.0077 | 0.0117 | 0.0113 |
| @ 10 | | | | | | | | | | |
| GHz | | | | | | | | | | |

TABLE 6

| (mol %) | Ex. 51 | Ex. 52 | Ex. 53 |
|---|---|---|---|
| SiO₂ | 67.2 | 56.1 | 67.7 |
| Al₂O₃ | 13.1 | 17.2 | 15.4 |
| B₂O₃ | 3.6 | 0.0 | 0.0 |
| P₂O₅ | 0.0 | 7.0 | 0.0 |
| MgO | 2.3 | 2.7 | 0.0 |
| CaO | 0.0 | 0.0 | 0.0 |
| SrO | 0.0 | 0.0 | 0.0 |
| BaO | 0.0 | 0.0 | 0.0 |
| ZnO | 0.0 | 0.0 | 0.0 |
| TiO₂ | 0.0 | 0.0 | 0.0 |
| ZrO₂ | 0.0 | 0.2 | 0.0 |
| Y₂O₃ | 0.0 | 0.0 | 0.0 |
| Li₂O | 0.0 | 0.0 | 6.2 |
| Na₂O | 13.7 | 16.8 | 10.7 |
| K₂O | 0.1 | 0.0 | 0.0 |
| Sum | 100.0 | 100.0 | 100.0 |
| Mg + Ca + Sr + Ba | 2.3 | 2.7 | 0.0 |
| X | 14.2 | 20.7 | 31.0 |
| Y | 22.1 | 26.8 | 23.7 |
| Z | 83.3 | 118.8 | 76.6 |
| Y + Z | 105.4 | 145.6 | 100.3 |
| CS₀ (Na) [MPa] | — | — | 125 |
| DOL [μm] | — | — | 129 |
| ε′ @10 GHz | 6.8 | 7.6 | 6.9 |
| tan δ @10 GHz | 0.0250 | 0.0193 | 0.0075 |

In the glasses of Examples 1 to 50, which are Examples, the surface compressive stress value after chemical strengthening was more than 230 MPa, and excellent strength was obtained by chemical strengthening.

In addition, it was confirmed that the glasses of Examples 1 to 50 had good values for the relative permittivity ϵ′ and dielectric loss tangent tan δ at 20° C. and 10 GHz, and had excellent radio wave transparency.

On the other hand, the glasses of Examples 51 and 52, which are Comparative Examples, do not contain lithium ions, and it was difficult to increase the strength by chemical strengthening using sodium salts. Further, the glasses of Examples 51 and 52 had a large relative permittivity and tan δ, and did not have good radio wave transparency. In the glass of Example 53, the tan δ was small, but the surface compressive stress value after chemical strengthening was not sufficient, and both the strength and the radio wave transparency cannot be satisfied.

Although the present invention has been described in detail with reference to specific embodiments, it is apparent to those skilled in the art that various changes and modifications can be made without departing from the spirit and scope of the present invention. The present application is based on a Japanese Patent Application (No. 2020-115920) filed on Jul. 3, 2020, and the content thereof is incorporated herein by reference.

1. A glass comprising, in terms of mole percentage based on oxides:
50.0 to 75.0% of SiO₂;
7.5 to 25.0% of Al₂O₃;
0 to 25.0% of B₂O₃;
6.5 to 20.0% of Li₂O;
1.5 to 10.0% of Na₂O;
0 to 4.0% of K₂O;
1.0 to 20.0% of MgO;
one or more components selected from MgO, CaO, SrO, and BaO in a total amount of 1.0 to 20.0%; and
0 to 5.0% of TiO₂,
wherein a value of Y calculated based on the following formula is 19.5 or less,
Y=1.2×([MgO]+[CaO]+[SrO]+[BaO])+1.6×([Li₂O]+[Na₂O]+[K₂O])
provided that [MgO], [CaO], [SrO], [BaO], [Li₂O], [Na₂O], and [K₂O] are contents, in terms of mole percentage based on oxides, of components of MgO, CaO, SrO, BaO, Li₂O, Na₂O, and K₂O respectively.

2. The glass according to claim 1, wherein a value of X calculated based on the following formula is 30.0 or more,
X=3×[Al₂O₃]+[MgO]+[Li₂O]−2×([Na₂O]+[K₂O])
provided that [Al₂O₃], [MgO], [Li₂O], [Na₂O], and [K₂O] are contents, in terms of mole percentage based on oxides, of components of Al₂O₃, MgO, Li₂O, Na₂O, and K₂O respectively.

3. A glass comprising, in terms of mole percentage based on oxides:
55.0 to 75.0% of SiO₂;
9.1 to 25.0% of Al₂O₃;
0 to 14.0% of B₂O₃;
7.5 to 12.5% of Li₂O;
3.6 to 10.0% of Na₂O;
0 to 2.0% of K₂O;
one or more components selected from MgO, CaO, SrO, and BaO in a total amount of 0 to 13.0%; and
0 to 8.0% of ZnO,
wherein a value of X is 25.0 or more and a value of Z is 22.0 or less, the values of X and Z being calculated based on the following formulas,
X=3×[Al₂O₃]+[MgO]+[Li₂O]−2×([Na₂O]+[K₂O])
Z=3×[Al₂O₃]−3×[B₂O₃]−2×[Li₂O]+4×[Na₂O]
provided that [Al₂O₃], [B₂O₃], [MgO], [Li₂O], [Na₂O], and [K₂O] are contents, in terms of mole percentage based on oxides, of components of Al₂O₃, B₂O₃, MgO, Li₂O, Na₂O, and K₂O respectively.

4. A glass comprising, in terms of mole percentage based on oxides:
50.0 to 75.0% of SiO₂;
9.0 to 25.0% of Al₂O₃;
0 to 20.0% of B₂O₃;
6.5 to 14.5% of Li₂O;
2.5 to 10.0% of Na₂O;
0 to 4.0% of K₂O;
one or more components selected from MgO, CaO, SrO, and BaO in a total amount of 0 to 20.0%; and
0 to 3.0% of TiO₂,
wherein a value of X is 35.0 or more and a total value of Y and Z is 35.0 or less, the values of X, Y, and Z being calculated based on the following formulas,
X=3×[Al₂O₃]+[MgO]+[Li₂O]−2×([Na₂O]+[K₂O])
Y=1.2×([MgO]+[CaO]+[SrO]+[BaO])+1.6×([Li₂O]+[Na₂O]+[K₂O])
Z=3×[Al₂O₃]−3×[B₂O₃]−2×[Li₂O]+4×[Na₂O]
provided that [Al₂O₃], [B₂O₃], [MgO], [CaO], [SrO], [BaO], [Li₂O], [Na₂O], and [K₂O] are contents, in terms of mole percentage based on oxides, of components of Al₂O₃, B₂O₃, MgO, CaO, SrO, BaO, Li₂O, Na₂O, and K₂O respectively.

5. The glass according to claim 1, having a sheet thickness (t) of 100 μm or more and 2000 μm or less.

6. A chemically strengthened glass having a base composition comprising, in terms of mole percentage based on oxides:
50.0 to 75.0% of SiO₂;
0 to 25.0% of B₂O₃;
7.5 to 25.0% of Al₂O₃;
6.5 to 20.0% of Li₂O;
1.5 to 10.0% of Na₂O;
0 to 4.0% of K₂O;
1.0 to 20.0% of MgO;
one or more components selected from MgO, CaO, SrO, and BaO in a total amount of 1.0 to 20.0%; and
0 to 5.0% of TiO₂,
wherein a value of Y calculated based on the following formula is 19.5 or less,
Y=1.2×([MgO]+[CaO]+[SrO]+[BaO])+1.6×([Li₂O]+[Na₂O]+[K₂O])
provided that [MgO], [CaO], [SrO], [BaO], [Li₂O], [Na₂O], and [K₂O] are contents, in terms of mole percentage based on oxides, of components of MgO, CaO, SrO, BaO, Li₂O, Na₂O, and K₂O respectively.

7. The chemically strengthened glass according to claim 6, having a surface compressive stress value CS₀ of 300 MPa or more.

8. The chemically strengthened glass according to claim 6, having a compressive stress value CS₅₀ at a depth of 50 μm from a glass surface of 75 MPa or more and a sheet thickness (t) of 300 μm or more.

9. The chemically strengthened glass according to claim 6, having a depth of a compressive stress layer DOL of 80 μm or more and a sheet thickness (t) of 350 μm or more.

10. A glass ceramics having the glass composition of the glass according to claim 1.
